(19) United States
(12) Patent Application Publication
(10) Pub. No.: US 2017/0285326 A1
(43) Pub. Date: Oct. 5, 2017

(54) OPTICAL SWEEPER, IMAGE DISPLAY APPARATUS, AND HEAD MOUNTED DISPLAY

(71) Applicant: Seiko Epson Corporation, Tokyo (JP)

(72) Inventor: Daisuke ISHIDA, Chino (JP)

(21) Appl. No.: 15/472,654

(22) Filed: Mar. 29, 2017

(30) Foreign Application Priority Data
Mar. 30, 2016 (JP) 2016-068277

(51) Int. Cl. G02B 26/08; G02B 27/01

(52) U.S. Cl. CPC G02B 26/0816; G02B 27/0172; G02B 2027/0178

(57) ABSTRACT

An optical scanner includes a movable section having a light reflection surface, a shaft section that supports the movable section swingably around an axis of swing motion, a support section that supports the shaft section, and a holding section that holds the support section from a side facing the light reflection surface. A reflection reduction section is disposed on a surface of the holding section, the surface located on a side opposite the movable section. The holding section has an opening, and at least part of the light reflection surface falls within the opening in a plan view of the light reflection surface.

### BACKGROUND

### 1. Technical Field

The present invention relates to an optical scanner, an image display apparatus, and a head mounted display.

### 2. Related Art

JP-A-2009-216938 discloses an optical scanner that scans light. The optical scanner disclosed in JP-A-2009-216938 includes a support body, an optical scanner supported by the support body, and a cap-shaped light shield member supposed by the support body and so disposed as to cover the optical scanner. The optical scanner includes a movable section having a mirror surface, a support section disposed around the movable section, and a linkage section that links the movable section to the support section in a pivotable manner. In the thus configured optical scanner, the light shield member can reduce stray light.

In the configuration described in JP-A-2009-216938, however, the top surface of the light shield member (portion facing principal surface of optical scanner) is separate from the principal surface of the optical scanner in the height direction thereof. It is therefore difficult to reduce the size (height) of the optical scanner due to the increased height of the optical scanner.

### SUMMARY

An advantage of some aspects of the invention is to provide an optical scanner, an image display apparatus, and a head mounted display that allow size reduction.

The advantage can be achieved by the following aspects of the invention.

An optical scanner according to an aspect of the invention includes a movable section having a light reflection surface, a support section that supports the movable section swingably around an axis of swing motion, and a holding section that holds the support section from a side facing the light reflection surface.

The configuration in which the holding section holds the support section from the side facing the light reflection surface allows the size of the optical scanner to be reduced.

In the optical scanner according to the aspect of the invention, it is preferable that a reflection reduction section is disposed on a surface of the holding section, the surface located on a side opposite the movable section.

With this configuration, stray light can be reduced.

In the optical scanner according to the aspect of the invention, it is preferable that the holding section has an opening, and that at least part of the light reflection surface falls within the opening in a plan view of the light reflection surface.

With this configuration, light scanning operation performed by the light reflection surface is not hindered.

In the optical scanner according to the aspect of the invention, it is preferable that an inner circumferential surface of the opening is so tapered that an area of the opening gradually increases in a direction separate away from the light reflection surface.

With this configuration, light scanning operation performed by the light reflection surface is unlikely to be hindered. Further, stray light can be more effectively reduced.

In the optical scanner according to the aspect of the invention, it is preferable that the surface of the holding section on the side opposite the movable section inclines with respect to the light reflection surface in a natural state.

With this configuration, the light with which the holding section is irradiated can be reflected in a direction different from the direction of the light reflected off the light reflection surface.

It is preferable that the optical scanner according to the aspect of the invention further includes a drive section that is located on a side opposite the light reflection surface of the movable section and causes the movable section to swing.

With this configuration, the configuration in which the drive section is located on the side opposite the light reflection surface of the movable section as described above allows the drive section to be close to the movable section without interference with the holding section. The movable section is therefore allowed to swing efficiently.

In the optical scanner according to the aspect of the invention, it is preferable that a gap between the movable section and the drive section is visually recognized when viewed in a direction perpendicular to a direction in which the movable section and the drive section are arranged.

With this configuration, the gap between the drive section and the movable section can be readily adjusted.

In the optical scanner according to the aspect of the invention, it is preferable that the holding section has a bottomed, recessed section that is open through a surface facing the movable section, and that at least part of the support section is disposed in the recessed section.

With this configuration, the size of the optical scanner can be reduced.

In the optical scanner according to the aspect of the invention, it is preferable that a wiring line is disposed on a surface of the holding section, the surface facing the movable section.

With this configuration, the wiring line may be connected, for example, to a sensor or any other component disposed on a shaft section that links the movable section to the support section, whereby the sensor or any other component can be readily electrically drawn.

An image display apparatus according to an aspect of the invention includes the optical scanner according to the aspect of the invention.

With this configuration, an image display apparatus that allows size reduction can be provided.

A head mounted display according to an aspect of the invention includes the optical scanner according to the aspect of the invention, and a frame that incorporate the optical scanner and is worn around a viewer's head.

With this configuration, a head mounted display that allows size reduction can be provided.

### BRIEF DESCRIPTION OF THE DRAWINGS

The invention will be described with reference to the accompanying drawings, wherein like numbers reference like elements.

FIG. 1 is a configuration diagram of an image display apparatus according to a first embodiment of the invention.

FIG. 2 is a cross-sectional view of an optical scanner provided in the image display apparatus shown in FIG. 1.

FIG. 3 is a plan view of an optical scanner main body of the optical scanner shown in FIG. 2.

FIG. 4 is a cross-sectional view taken along the line A-A in FIG. 3.

FIG. 5 is a plan view showing posture sensing sections of the optical scanner main body.

FIG. 6 is a plan view showing a base of the optical scanner.

FIG. 7 is a cross-sectional view showing an optical scanner according to a second embodiment of the invention.

FIG. 8 is a cross-sectional view showing an optical scanner according to a third embodiment of the invention.

FIG. 9 is a perspective view showing a head-up display.

FIG. 10 is a perspective view showing a head mounted display according to an embodiment of the invention.

### DESCRIPTION OF EXEMPLARY EMBODIMENTS

An optical scanner, an image display apparatus, and a head mounted display according to preferable embodiments of the invention will be described below with reference to the accompanying drawings.

### First Embodiment

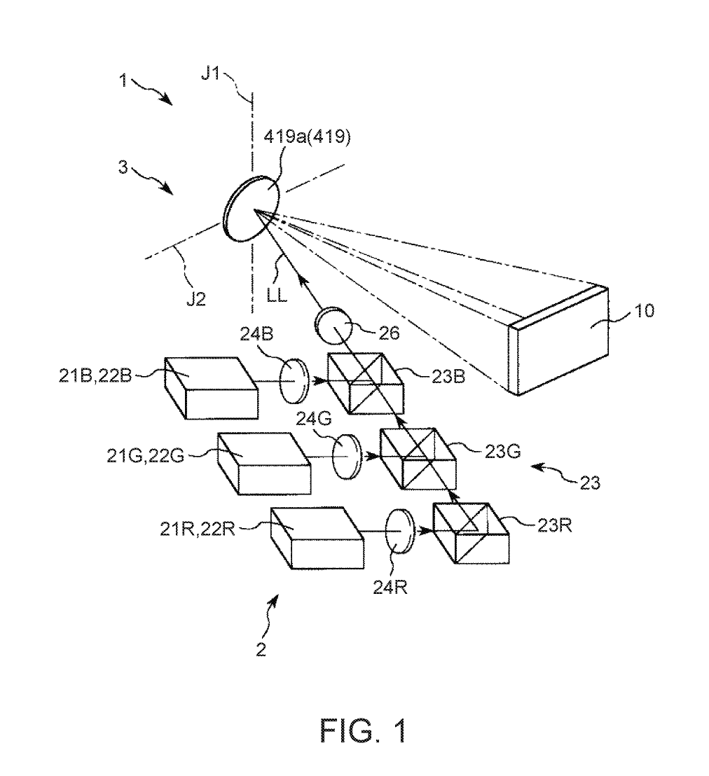

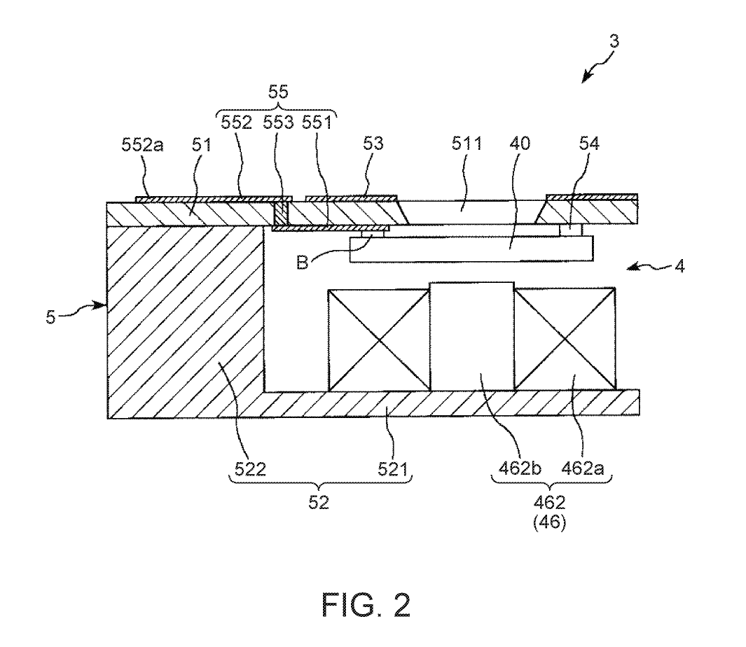

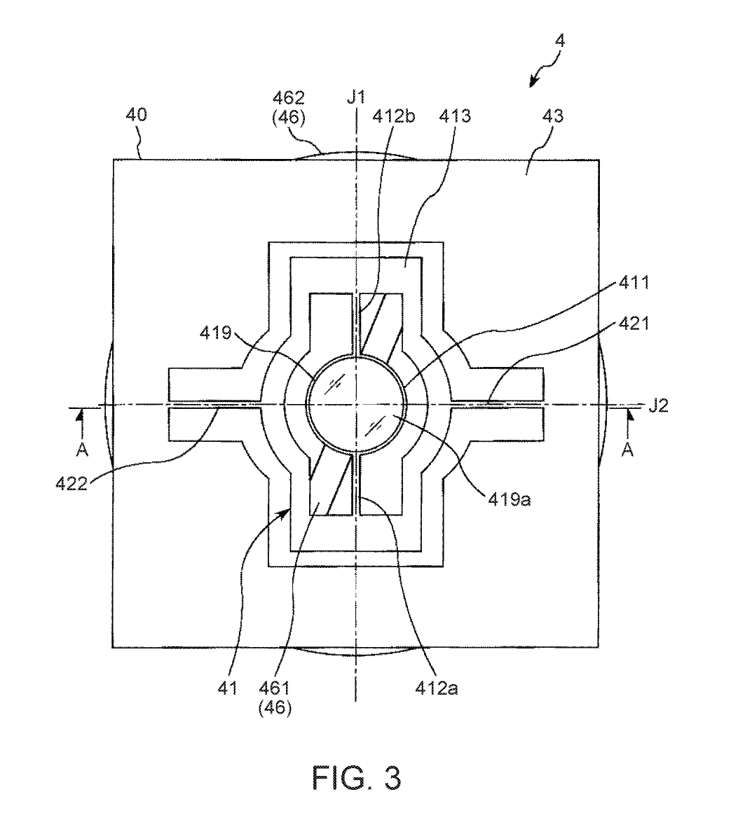

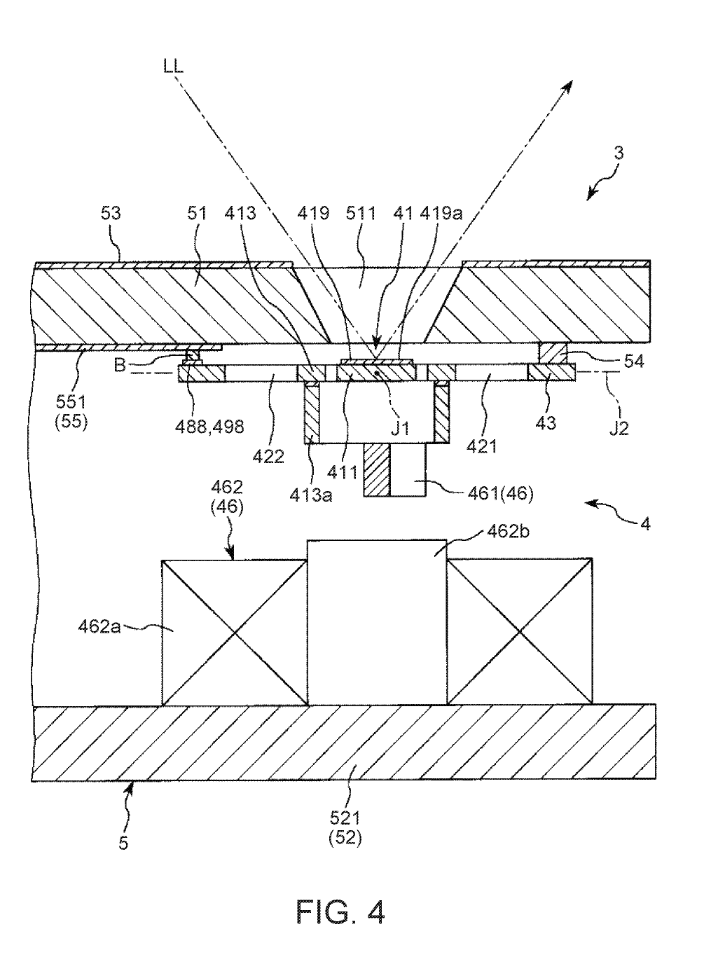

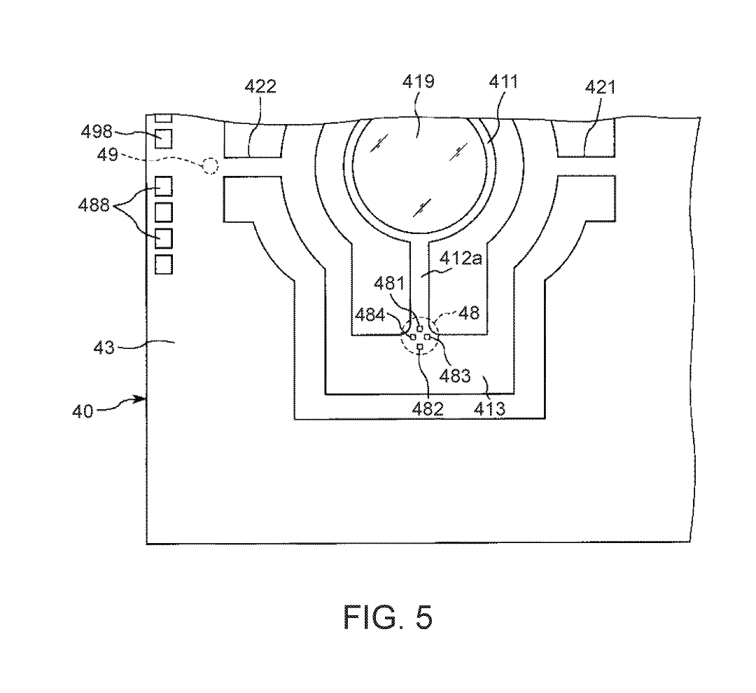

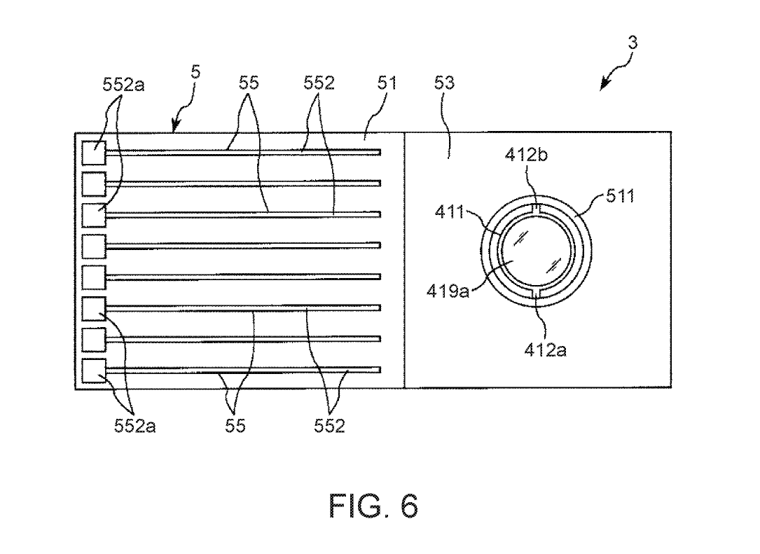

FIG. 1 is a configuration diagram of an image display apparatus according to a first embodiment of the invention. FIG. 2 is a cross-sectional view of an optical scanner provided in the image display apparatus shown in FIG. 1. FIG. 3 is a plan view of an optical scanner main body of the optical scanner shown in FIG. 2. FIG. 4 is a cross-sectional view taken along the line A-A in FIG. 3. FIG. 5 is a plan view showing posture sensing sections of the optical scanner main body. FIG. 6 is a plan view showing a base of the optical scanner. In the following sections, the upper side in FIG. 2 is also referred to as “upper,” and the lower side in FIG. 2 is also referred to as “lower,” for convenience of the description.

An image display apparatus 1 shown in FIG. 1 is an apparatus that two-dimensionally scans a drawing laser beam LL over an object 10, such as a screen and a wall surface, to display an image. The thus configured image display apparatus 1 includes a light source unit 2, which outputs the drawing laser beam LL, and an optical scanner 3, which two-dimensionally scans the laser beam LL outputted from the light source unit 2. The optical scanner 3 has a configuration that allows size reduction as will be described later, and the image display apparatus 1 including the optical scanner 3 therefore also allows size reduction. The image display apparatus 1 may further include, for example, a projection lens.

### Light Source Unit

The light source unit 2 includes a light source section having laser light sources 21R, 21G, and 21B, which emit red, green, and blue laser beams, respectively, drive circuits 22R, 22G, and 22B, which drive the laser light sources 21R, 21G, and 21B, respectively, collimator lenses 24R, 24G, and 24B, which parallelize the laser beams emitted from the laser light sources 21R, 21G, and 21B, respectively, a light combiner 23, and a light collection lens 26, as shown in FIG. 1.

The laser light source 21R is a light source that emits red light. The laser light source 21G is a light source that emits green light. The laser light source 21B is a light source that emits blue light. Use of the three color light beams allows a full-color image to be displayed. Each of the laser light sources 21R, 21G, and 21B is not limited to a specific light source and can, for example, be a laser diode or an LED.

The drive circuit 22R drives the laser light source 21R. The drive circuit 22G drives the laser light source 21G. The drive circuit 22B drives the laser light source 21B. The drive operation of each of the drive circuits 22R, 22G, and 22B is independently controlled by a controller that is not shown. The three laser beams emitted from the laser light sources 21R, 21G, and 21B driven by the drive circuits 22R, 22G, and 22B are parallelized by the collimator lenses 24R, 24G, and 24B, respectively, and then incident on the light combiner 23.

The light combiner 23 combines the light beams from the laser light sources 21R, 21G, and 21B. The light combiner 23 includes three dichroic mirrors 23R, 23G, and 23B. The dichroic mirror 23R has a function of reflecting the red light. The dichroic mirror 23G has a function of transmitting the red light and reflecting the green light. The dichroic mirror 23B has a function of transmitting the red light and the green light and reflecting the blue light.

Use of the dichroic mirrors 23R, 23G, and 23B allows the three laser light beams, which are the red light, the green light, and the blue light, from the laser light sources 21R, 21G, and 21B, to be combined with one another. The controller modulates the intensities of the light beams from the laser light sources 21R, 21G, and 21B independently of one another to produce drawing laser beam LL (light) of a predetermine color. The thus produced laser beam LL passes through the light collection lens 26, which changes NA (numerical aperture) of the laser beam LL to a desired value, and the resultant laser beam LL is guided to the optical scanner 3.

The light source unit 2 has been described above. It is, however, noted that the configuration of the light source unit 2 is not limited to the configuration in the present embodiment and can have any configuration that allows the laser beam LL to be produced.

### Optical Scanner

The optical scanner 3 includes an optical scanner main body 4 and a base 5, which holds the optical scanner main body 4, as shown in FIG. 2.

The optical scanner main body 4 includes a structural body 40, which has a movable section 41, a support section 43, which supports the movable section 41 swingably (pivotably) around the axis of swing motion J1 and J2, and shaft sections 421 and 422, which link the movable section 41 to the support section 43, and a drive mechanism 46, which causes the movable section 41 to swing around the axes of swing motion J1 and J2, as shown in FIGS. 3 and 4.

The movable section 41 has a first movable section 411, shaft sections 412a and 412b, which support the first movable section 411 swingably (pivotable) around the axis of swing motion J1, and a frame-shaped second movable section 413, which supports the shaft sections 412a and 412b, and movable section 41 is connected to the shaft sections 421 and 422 via the second movable section 413.

The first movable section 411 has a plate-like shape. A light reflector 419 is provided on the upper surface of the first movable section 411. The light reflector 419 has light reflectivity, and a surface of the light reflector 419 forms a light reflection surface 419a, which reflects the laser beam LL. The laser beam LL incident on the light reflection surface 419a is therefore reflected off the light reflection surface 419a and scanned in a direction according to the posture of the light reflection surface 419a. The thus configured light reflector 419 can be formed, for example, of a metal film made of aluminum or any other material.

The shaft sections 412a and 412b are so disposed on opposite sides of the first movable section 411 as to support the first movable section 411 on both sides. Each of the shaft sections 412a and 412b extends along the axis of swing motion J1, with one end of the shaft section connected to the first movable section 411 and the other end of the shaft section connected to the second movable section 413. The shaft sections 412a and 412b support the first movable section 411 swingably around the axis of swing motion J1 and are torsionally deformed when the first movable section 411 swings around the axis of swing motion J1. The shape of the shaft sections 412a and 412b is not limited to the shape in the present embodiment and may be any shape that allows the first movable section 411 to be supported swingably around the axis of swing motion J1.

The second movable section 413 has a frame-like shape and is so disposed as to surround the circumference of the first movable section 411 in a plan view. That is, the first movable section 411 is disposed inside the second movable section 413. The lower surface of the second movable section 413 is provided with a rib 413a, and a permanent magnet 461 is provided on the lower surface of the rib 413a, as shown in FIG. 4. The rib 413a has a function as a reinforcement section that reinforces the mechanical strength of the second movable section 413 and a function as a gap member for ensuring a space that is located between the first movable section 411 and the permanent magnet 461 and prevents the first movable section 411 and the permanent magnet 461 from coming into contact with each other.

The shaft sections 421 and 422 are so disposed on the opposite sides of the second movable section 413 as to support the second movable section 413 on both sides. Each of the shaft sections 421 and 422 extends along the axis of swing motion J2, with one end of the shaft section connected to the second movable section 413 and the other end of the shaft section connected to the support section 43. The shaft sections 421 and 422 support the second movable section 413 swingably around the axis of swing motion J2 and is torsionally deformed when the second movable section 413 swings around the axis of swing motion J2. The shape of the shaft sections 421 and 422 is not limited to the shape in the present embodiment and may be any shape that allows the second movable section 413 to be supported swingably around the axis of swing motion J2.

The support section 43 has a frame-like shape and is so disposed as to surround the movable section 41 in a plan view. The support section 43 is connected to the shaft sections 421 and 422 and supports the shaft sections 421 and 422. The shape of the support section 43 is not limited to a specific shape and can be any shape that allows the shaft sections 421 and 422 to be supported. For example, the support section 43 may be divided into a portion that supports the shaft section 421 and a portion that supports the shaft section 422.

The structural body 40 has been described above. The structural body 40 can be integrally formed, for example, by etching an SOI substrate [a substrate having a first Si layer (device layer), an SiO₂ layer (box layer), a second Si layer (handle layer) stacked on each other in this order]. Specifically, the first movable section 411, the shaft sections 412a and 412b, the shaft sections 421 and 422, and the support section 43 can be formed from the device layer, and the second movable section 413 can be formed from the device layer, the box layer, and the handle layer. These components can thus be formed integrally with one another.

The drive mechanism 46 includes the permanent magnet 461, which is provided to the lower surface of the rib 413a, and a coil 462, which is so located on the opposite side of the light reflection surface 419a of the movable section 41 as to face the permanent magnet 461 and serves as a drive section that produces a magnetic field acting on the permanent magnet 461 to cause the movable section 41 to swing, as shown in FIG. 4. The configuration in which the coil 462 is located on the opposite side of the light reflection surface 419a of the movable section 41 allows the coil 462 to be close to the movable section 41 without the base 5 interfering with the coil 462, as will be described later, for efficiently swing motion of the movable section 41.

The permanent magnet 461 has a rod-like shape with one end side forming the S pole and the other end side forming the N pole, and the permanent magnet 461 is so disposed as to incline with respect both to the axes of swing motion J1 and J2 in a plan view. The permanent magnet 461 can, for example, be a neodymium magnet, a ferrite magnet, a samarium-cobalt magnet, an alnico magnet, or a bonded magnet.

To the coil 462 is applied superimposed voltage formed of first alternate voltage for causing the first movable section 411 to swing around the axis of swing motion J1 and second alternate voltage for causing the second movable section 413 to swing around the axis of swing motion J2 with the first alternate voltage and the second alternate voltage superimposed on each other. The application of the superimposed voltage allows the first movable section 411 to swing around the axis of swing motion J1 with the second movable section 413 swinging around the axis of swing motion J2. As a result, the first movable section 411 swings around both the axes of swing motion J1 and J2. It is preferable that the swing motion of the first movable section 411 around the axis of swing motion J1 is produced by resonant drive operation, and that the swing motion of the second movable section 413 around the axis of swing motion J2 is produced by non-resonant drive operation. It is further preferable that the first alternate voltage is sinusoidal-wave voltage oscillating at a frequency ranging from about 10 to 40 kHz, and that the second alternate voltage is saw-toothed-wave voltage oscillating at a frequency ranging from about 30 to 120 Hz (about 60 Hz). The drive operation described above allows the light reflection surface 419a to perform swing motion appropriate for image drawing.

The coil 462 in the present embodiment has a coil main body 462a and a core 462b, around which the coil main body 462a is wound, and the upper surface of the core 462b protrudes from the coil main body 462a. Therefore, when the optical scanner 3 is viewed sideways, the upper surface (upper end) of the core 462b is visually recognized, whereby the gap between the core 462b and the permanent magnet 461 can be precisely adjusted.

To display a predetermined image by scanning the laser beam LL with the light reflection surface 419a, it is necessary to sense the posture (angle of swing motion) of the first movable section 411 (light reflection surface 419a) and cause the light source unit 2 to output a laser beam LL of a predetermined color in accordance with the posture. To this end, the optical scanner main body 4 is provided with posture sensing sections 48 and 49 capable of sensing the posture of the first movable section 411, as shown in FIG. 5.

The posture sensing section 48 can sense the inclination (angle of swing motion) of the first movable section 411 around the axis of swing motion J1 on the basis of the amount of torsional deformation of the shaft section 412a, and the posture sensing section 49 can sense the inclination (angle of swing motion) of the first movable section 411 around the axis of swing motion J2 on the basis of the amount of torsional deformation of the shaft section 422. In the following description of the posture sensing sections 48 and 49, the posture sensing section 48 will be described as a representative one, and no description of the posture sensing section 49 will be made because the two posture sensing sections have the same configuration except that they are disposed at different locations.

The posture sensing section 48 has four piezo-resistive sections 481, 482, 483, and 484, which are provided in a portion where the shaft section 412a is connected to the second movable section 413, as shown in FIG. 5. Each of the piezo-resistive sections 481, 482, 483, and 484 receives stress according to the amount of torsional deformation of the shaft section 412a, and the resistance of the piezo-resistive section changes accordingly. The piezo-resistive sections 481, 482, 483, and 484 are electrically connected to each other via wiring lines that are not shown to form a bridge circuit (Wheatstone bridge circuit). The piezo-resistive sections 481, 482, 483, and 484 and the wiring lines described above can be formed by doping (diffusing or injecting) an impurity, such as phosphorous and boron, into the first Si layer (device layer) described above.

Although not shown, a plurality of wiring lines (wiring line for supplying drive voltage, wiring line for extracting detection signal) are connected to the bridge circuit, and each of the wiring lines is routed via the shaft section 421 or the shaft section 422 to the support section 43 and connected to terminals 488, which are disposed on the upper surface of the support section 43. Since the bridge circuit outputs a detection signal according to the resistance values of the piezo-resistive sections 481, 482, 483, and 484, the amount of torsional deformation of the shaft section 412a can be sensed from the detection signal, and the inclination of the first movable section 411 around the axis of swing motion J1 can be sensed from the amount of torsional deformation of the shaft section 412a.

In the following description, terminals with which the posture sensing section 49 is provided and which correspond to the terminals 488 of the posture sensing section 48 are also referred to as “terminals 498.”

The optical scanner main body 4 has been described. The base 5, which holds the optical scanner main body 4, will next be described.

The base 5 includes a holding section 51, which holds the structural body 40, and a coil holding section 52, which is connected to the holding section 51 and holds the coil 462 (drive section), as shown in FIG. 2. The holding section 51 has a plate-like shape and holds the support section 43 of the structural body 40 from above (that is, the side facing the light reflection surface 419a), as shown in FIG. 4. In the present embodiment, the structural body 40 is held by the holding section 51 in a configuration in which the holding section 51 and the support section 43 are bonded to each other via a bonding member 54. The size of the optical scanner 3 can be reduced in the configuration in which the holding section 51 holds the structural body 40 from above as described above. For example, in contrast to the present embodiment, in a case where the holding section 51 holds the structural body 40 from below, the coil 462 cannot be sufficiently close to the permanent magnet 461 because the coil 462 interferes with the holding section 51, and the magnetic field produced by the coil 462 could not undesirably be allowed to efficiently act on the permanent magnet 461. In contrast, according to the present embodiment, in which the holding section 51 holds the structural body 40 from above (the side opposite the coil 462), the coil 462 is allowed to be sufficiently close to the permanent magnet 461. The magnetic field produced by the coil 462 is allowed to efficiently act on the permanent magnet 461, whereby the movable section 41 is allowed to swing more efficiently.

Further, the holding section 51 has an opening 511 formed of a through hole that passes through the holding section 51 in the thickness direction thereof. At least part of the light reflection surface 419a falls within the opening 511 in a plan view, as shown in FIG. 6. The laser beam LL outputted from the light source unit 2 passes through the opening 511 and is incident on the light reflection surface 419a, and the laser beam LL reflected off and scanned by the light reflection surface 419a passes through the opening 511. The presence of the opening 511 avoids a situation in which the scanning operation of the laser beam LL performed by the light reflection surface 419a is hindered. In the present embodiment, in particular, the inner circumferential surface of the opening 511 is so tapered that the area of the opening gradually increases in the direction separate away from the light reflection surface 419a (that is, upward direction). The incidence of the laser beam LL on the light reflection surface 419a and the scanning of the laser beam LL reflected off the light reflection surface 419a are therefore unlikely to be hindered. Further, since the laser beam LL is unlikely to be incident on the inner circumferential surface, stray light can be more effectively reduced. In the present embodiment, the opening 511 has a circular shape, but the shape of the opening 511 is not limited to a specific shape and may, for example, be a rectangular shape. Further, the inner circumferential surface of the opening 511 is not necessarily tapered.

In particular, in the present embodiment, the opening 511 is so formed as to contain the entire first movable section 411 in a plan view. Further, the opening 511 is so formed as not to overlap with the second movable section 413. That is, the first movable section 411 is visually recognized through the opening 511, but the second movable section 413 is not. As a result, the possibility of irradiation of the second movable section 413 with the laser beam LL can be lowered, whereby stray light can be more effectively reduced. The bonding member 54, which bonds the holding section 51 and the structural body 40 to each other, also functions as a gap member for ensuring a space that is located between the holding section 51 and the structural body 40 and allows the second movable section 413 to swing.

An antireflection film 53 as a reflection reduction section is disposed on the upper surface of the holding section 51 (surface opposite movable section 41). The antireflection film 53 disposed on the upper surface of the holding section 51 allows reduction in stray light that is part of the laser beam LL reflected off the holding section 51 without an increase in the size of the optical scanner 3. The antireflection film 53 is not limited to a specific film and can, for example, be a Cr film or a black resist. The configuration of the reflection reduction section is not limited to a specific configuration and may be any configuration that allows reduction in the amount of reflection of the laser beam LL off the holding section 51 as compared with a case where no reflection reduction section is disposed.

A plurality of wiring lines 55 are disposed in and on the holding section 51, as shown in FIG. 2. Each of the wiring lines 55 is formed of a first wiring line section 551, which is disposed on the lower surface of the holding section 51 (surface facing movable section 41), a second wiring line section 552, which is disposed on the upper surface of the holding section 51, and a through electrode 553, which connects the first wiring line section 551 and the second wiring line section 552 to each other and is so disposed as to pass through the holding section 51. An end portion of each of the second wiring line sections 552 forms a terminal 552a, which allows electrical connection to an external apparatus. The first wiring line sections 551 of the wiring lines 55 are electrically connected to the terminals 488 or 498 disposed on the support section 43 of the structural body 40 via electrically conductive bumps B. According to the configuration described above, the posture sensing sections 48 and 49 are readily electrically drawn and readily electrically connected to an external apparatus.

The coil holding section 52 includes a base section 521, which holds the coil 462 from below, and a connection section 522, which connects the base section 521 and the holding section 51 to each other and functions as a gap member for managing the gap between the permanent magnet 461 and the coil 462, as shown in FIG. 2. The coil holding section 52 is so configured that the gap between the movable section 41 (permanent magnet 461) and the coil 462 is visually recognized when viewed in the direction perpendicular to the direction in which the movable section 41 and the coil 462 (drive section) are arranged (that is, in the cross-sectional view of FIG. 2). The gap between the permanent magnet 461 and the coil 462 can therefore be more precisely managed (adjusted).

In the present embodiment, the base section 521 and the connection section 522 are integrated with each other. Instead, they may be formed as separate members and bonded to each other via a bonding member.

The base 5 has been described above. The materials of which the holding section 51 and the coil holding section 52 are made are not limited to specific materials and are each preferably a material having a linear expansion coefficient close to that of silicon of which the structural body 40 is made. As a result, thermal stress that could be induced in the structural body 40 can be reduced, whereby degradation in vibration characteristics of the structural body 40 can be reduced. Examples of the material may include alumina, silica, titania, zirconia, and other oxide ceramic materials, silicon nitride, aluminum nitride, titanium nitride, and other nitride ceramic materials, and a variety of other ceramic materials.

### Second Embodiment

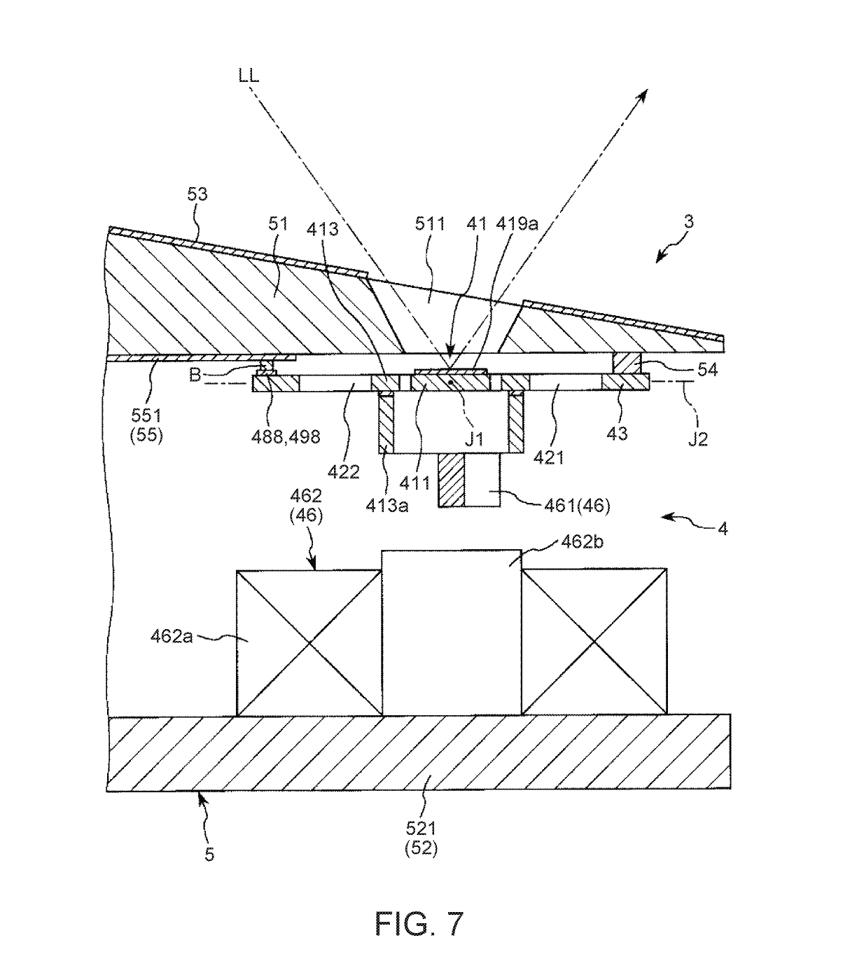

FIG. 7 is a cross-sectional view showing an optical scanner according to a second embodiment of the invention.

An image display apparatus according to the second embodiment will be described below primarily on differences from the first embodiment described above, and the same items will not be described.

The image display apparatus according to the second embodiment of the invention is the same as the image display apparatus according to the first embodiment described above except that the optical scanner is configured differently. The same configurations as those in the embodiment described above have the same reference characters.

In the optical scanner 3 according to the present embodiment, the upper surface of the holding section 51 (surface opposite movable section 41) inclines with respect to the light reflection surface 419a in a natural state, as shown in FIG. 7. The configuration relatively easily allows the laser beam LL incident on the holding section 51 to be reflected in a direction different from the direction of the laser beam LL scanned by the light reflection surface 419a. Stray light can therefore be more effectively reduced. The term “natural state” described above refers to a state in which no force that causes the movable section 41 to swing (magnetic field produced in coil 462 in present embodiment) acts on the movable section 41. The inclination direction of the upper surface of the holding section 51 is not limited to the direction in the present embodiment.

The second embodiment described above can also provide the same advantageous effects as those provided by the first embodiment described above.

### Third Embodiment

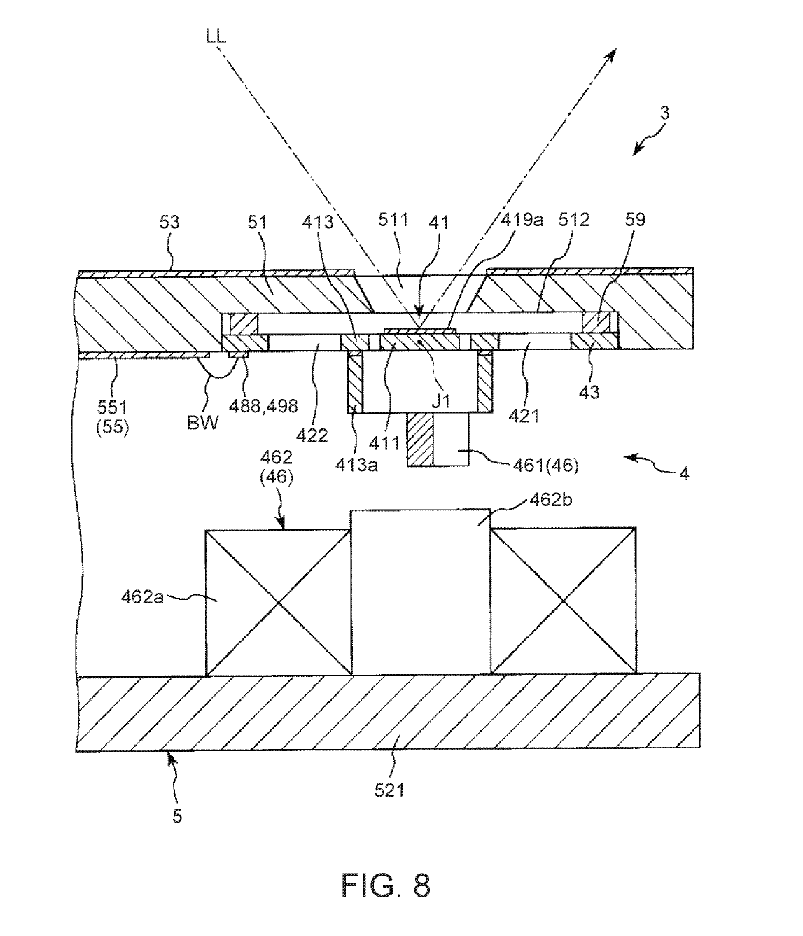

FIG. 8 is a cross-sectional view showing an optical scanner according to a third embodiment of the invention.

An image display apparatus according to the third embodiment will be described below primarily on differences from the embodiments described above, and the same items will not be described.

The image display apparatus according to the third embodiment of the invention is the same as the image display apparatus according to the first embodiment described above except that the optical scanner is configured differently. The same configurations as those in the embodiments described above have the same reference characters.

In the optical scanner 3 according to the present embodiment, the holding section 51 has a bottomed, recessed section 512, which is open through the lower surface of the holding section 51 (surface facing movable section 41), and the opening 511 is so formed as to pass through the top surface of the recessed section 512, as shown in FIG. 8. At least part of the support section 43 is so disposed as to be buried in the recessed section 512. In particular, in the present embodiment, the support section 43 is so buried in the recessed section 512 that the lower surface of the support section 43 is flush with the lower surface of the holding section 51. Burying at least part of the structural body 40 in the recess 512 as described above allows reduction in size (height) of the optical scanner 3.

A gap member 59, which fixes the support section 43 to the top surface of the recess 512 and ensures a space that is located between the top surface and the structural body 40 and allows the second movable section 413 to swing, is disposed between the top surface of the recessed section 512 and the support section 43.

The terminals 488 and 498 are disposed on the lower surface of the support section 43. The terminals 488 and 498 are electrically connected to wiring lines 489 and 499, which are disposed on the upper surface of the support section 43, via through electrodes so disposed as to pass through the support section 43. The terminals 488 and 498 are further electrically connected to the first wiring line sections 551 via bonded wires BW. Since the lower surface of the support section 43 is flush with the lower surface of the holding section 51 as described above, the connection by using the bonded wires BW can be readily performed.

The third embodiment described above can also provide the same advantageous effects as those provided by the first embodiment described above.

### Fourth Embodiment

A head-up display according to a fourth embodiment of the invention will next be described.

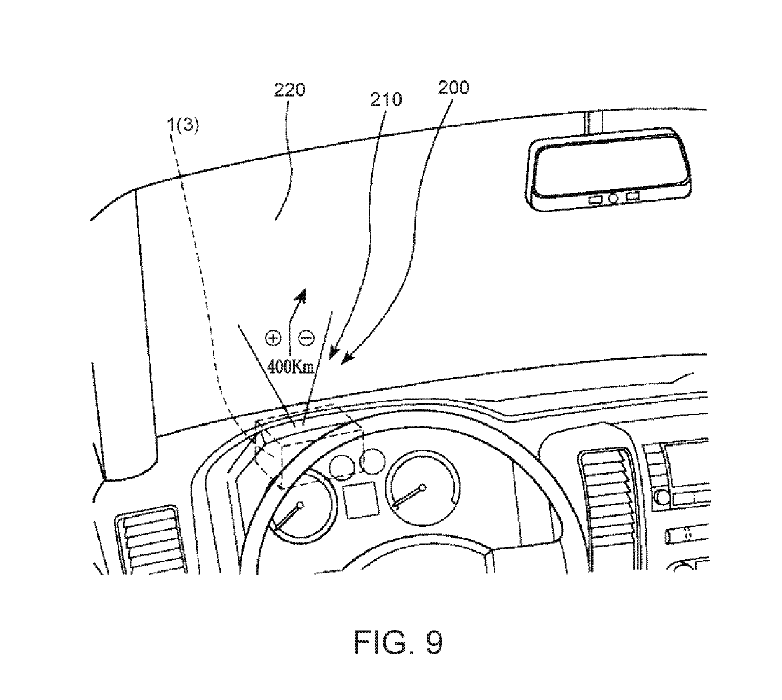

FIG. 9 is a perspective view showing the head-up display.

In a head-up display system 200, the image display apparatus 1 (optical scanner 3) is so incorporated in a dashboard of an automobile as to form a head-up display 210, as shown in FIG. 9. The head-up display 210 can display a predetermined image that shows a guide to a destination, the time, the direction, the speed, the outer air temperature, the weather, and other pieces of information on a windshield 220. According to the configuration described above, which includes the optical scanner 3 that allows size reduction, the size of the head-up display system 200 can be reduced.

The head-up display system 200 is not necessarily used with an automobile but may be used, for example, with an airplane and a ship.

### Fifth Embodiment

A head mounted display according to a fifth embodiment of the invention will next be described.

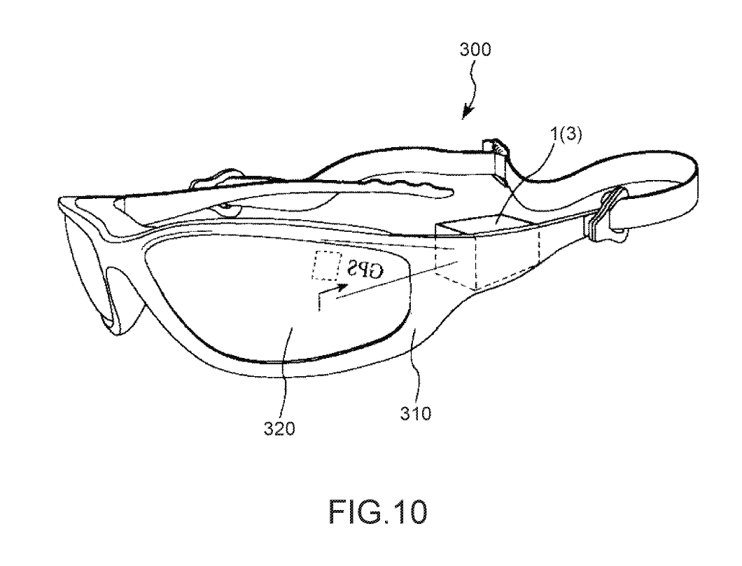

FIG. 10 is a perspective view showing the head mounted display according to the embodiment of the invention.

Ahead mounted display 300 includes the image display apparatus 1 (optical scanner 3) and a frame 310, which incorporates the image display apparatus 1 (optical scanner 3) and is worn around a viewer's head, as shown in FIG. 10. The image display apparatus 1 displays a predetermined image in a display section (light reflection layer) 320, which is provided in the frame 310, specifically, in a portion that originally functions as a lens, and the image is visually recognized with one of the eyes. The display section 320 may be transparent or opaque. When the display section 320 is transparent, information from the image display apparatus 1 can be superimposed on information (scene) from the real world for use. Further, the display section 320 only needs to reflect at least part of light incident thereon and can, for example, be a hologram element or a half-silvered mirror. According to the configuration described above, which includes the optical scanner 3 that allows size reduction, the size of the head mounted display 300 can be reduced.

The optical scanner, the image display apparatus, and the head mounted display according to the embodiments of the invention have been described with reference to the drawings, but the invention is not limited to the embodiments. The configuration of each of the portions can be replaced with an arbitrary configuration having the same function. Further, other arbitrary components may be added to the embodiments of the invention.

The above embodiments have been described with reference to the configuration of the optical scanner capable of scanning a laser beam two-dimensionally (around axes of swing motion J1 and J2), but the configuration of the optical scanner is not limited thereto. For example, the optical scanner may have a configuration that allows the laser beam to be scanned one-dimensionally. Specifically, for example, the shaft sections 412a and 412b and the second movable section 413 may be omitted from the configuration of the optical scanner main body 4 described in the first embodiment, and the shaft sections 421 and 422 may link the first movable section 411 to the support section 43. In this case, two optical scanners are so provided that one of the optical scanners scans the laser beam in the horizontal direction (first direction) and the other optical scanner scans the laser beam in the vertical direction (second direction that intersects first direction), whereby the laser beam can be scanned two-dimensionally.

The above embodiments have also been described with reference to the configuration in which the movable section is provided with the permanent magnet and the coil is so disposed as to face the permanent magnet. The arrangement of the permanent magnet and the coil may be reversed. That is, the movable section may be provided with the coil, and the permanent magnet may be disposed as to face the coil. In this case, the permanent magnet forms the drive section.

The entire disclosure of Japanese Patent Application No. 2016-068277, filed Mar. 30, 2016 is expressly incorporated by reference herein in its entirety.

What is claimed is:

1. An optical scanner comprising:
a movable section having a light reflection surface;
a support section that supports the movable section swingably around an axis of swing motion; and
a holding section that holds the support section from a side facing the light reflection surface.

2. The optical scanner according to claim 1, wherein a reflection reduction section is disposed on a surface of the holding section, the surface located on a side opposite the movable section.

3. The optical scanner according to claim 1,
wherein the holding section has an opening, and
at least part of the light reflection surface falls within the opening in a plan view of the light reflection surface.

4. The optical scanner according to claim 3, wherein an inner circumferential surface of the opening is so tapered that an area of the opening gradually increases in a direction separate away from the light reflection surface.

5. The optical scanner according to claim 3, wherein the surface of the holding section on the side opposite the movable section inclines with respect to the light reflection surface in a natural state.

6. The optical scanner according to claim 1, further comprising a drive section that is located on a side opposite the light reflection surface of the movable section and causes the movable section to swing.

7. The optical scanner according to claim 6, wherein a gap between the movable section and the drive section is visually recognized when viewed in a direction perpendicular to a direction in which the movable section and the drive section are arranged.

8. The optical scanner according to claim 1,
wherein the holding section has a bottomed, recessed section that is open through a surface facing the movable section, and
at least part of the support section is disposed in the recessed section.

9. The optical scanner according to claim 1, wherein a wiring line is disposed on a surface of the holding section, the surface facing the movable section.

10. An image display apparatus comprising the optical scanner according to claim 1.

11. An image display apparatus comprising the optical scanner according to claim 2.

12. An image display apparatus comprising the optical scanner according to claim 3.

13. An image display apparatus comprising the optical scanner according to claim 4.

14. An image display apparatus comprising the optical scanner according to claim 5.

15. An image display apparatus comprising the optical scanner according to claim 6.

16. A head mounted display comprising:
the optical scanner according to claim 1; and
a frame that incorporate the optical scanner and is worn around a viewer's head.

17. A head mounted display comprising:
the optical scanner according to claim 2; and
a frame that incorporate the optical scanner and is worn around a viewer's head.

18. A head mounted display comprising:
the optical scanner according to claim 3; and
a frame that incorporate the optical scanner and is worn around a viewer's head.

19. A head mounted display comprising:
the optical scanner according to claim 4; and
a frame that incorporate the optical scanner and is worn around a viewer's head.

20. A head mounted display comprising:
the optical scanner according to claim 5; and
a frame that incorporate the optical scanner and is worn around a viewer's head.
